(19) United States
(12) Patent Application Publication
(10) Pub. No.: US 2008/0141111 A1
(43) Pub. Date: Jun. 12, 2008

(54) Method And System For Annotating Presence Information

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/609,405

(22) Filed: Dec. 12, 2006

(51) Int. Cl. G06F 17/00

(52) U.S. Cl. 715/230

(57) ABSTRACT

Methods and systems are described for annotating presence information. One method includes receiving a message from a first presence client associated with a first presentity, the message including annotation data and an identifier of at least a portion of a presence tuple associated with a second presentity. An association of the annotation data is stored with the at least a portion of the presence tuple associated with the second presentity. An indication of the stored association of the annotation data is provided.

### BACKGROUND

In today's presence systems, presence information about a user or a device provides some useful information about the user or the device. For example, the status of the user or device may be known via a presence system. Further, any information the owner of a presence tuple publishes to the presence tuple may be presented to a watcher, which is a presence entity that receives presence information from a presence service on behalf of a presence client.

A tuple, in its broadest sense, is a data object containing one or more elements. If a tuple contains a status element it is referred to as a presence tuple (RFC 2778) and the information stored in the status element is referred to as presence information and is typically limited to information about the “owner” of the tuple. The procedure for adding or updating information to a tuple is referred to as publishing information to the tuple, or simply “publishing to a tuple.” Today's presence systems generally restrict publishing to a tuple to the owner of a tuple. This limitation prevents other non-owner users of the presence system from adding or annotating information to a presence tuple that is owned by another user.

Accordingly, there exists a need for methods, systems, and computer program products for annotating presence information.

### SUMMARY

In one aspect of the subject matter disclosed herein, a method for annotating presence information is disclosed. The method includes receiving a message from a first presence client associated with a first presentity, the message including annotation data and an identifier of at least a portion of a presence tuple associated with a second presentity. The method also includes storing an association of the annotation data with the at least a portion of the presence tuple associated with the second presentity. The method further includes providing an indication of the stored association of the annotation data.

In another aspect of the subject matter disclosed herein, a system for annotating presence information is disclosed. The system includes a message router configured to receive a message from a first presence client associated with a first presentity, the message including annotation data and an identifier of at least a portion of a presence tuple associated with a second presentity. The system also includes an annotation service configured to store an association of the annotation data with the at least a portion of the presence tuple associated with the second presentity. The system further includes a notification handler configured to provide an indication of the stored association of the annotation data.

In another aspect of the subject matter disclosed herein, a method for annotating presence information is disclosed. The method includes receiving by a presence client associated with a first presentity an identifier of at least a portion of a presence tuple associated with a second presentity. The method also includes receiving annotation data compatible with a specified schema. The method further includes generating a message including the identifier and at least a portion of the annotation data in a format translatable into the specified schema. The method also includes sending the message to an annotation service enabling the service to associate the annotation data with the presence tuple associated with a second presentity.

In another aspect of the subject matter disclosed herein, a computer readable medium containing a computer program, executable by a machine, for annotating presence information is disclosed. The computer program includes executable instructions for receiving a message from a first presence client associated with a first presentity, the message including annotation data and an identifier of at least a portion of a presence tuple associated with a second presentity. The computer program also includes instructions for storing an association of the annotation data with the at least a portion of the presence tuple associated with the second presentity. The computer program further includes instructions for providing an indication of the stored association of the annotation data.

In another aspect of the subject matter disclosed herein, a system for annotating presence information is disclosed. The system includes means for receiving a message from a first presence client associated with a first presentity, the message including annotation data and an identifier of at least a portion of a presence tuple associated with a second presentity. The system also includes means for storing an association of the annotation data with the at least a portion of the presence tuple associated with the second presentity. The system further includes means for providing an indication of the stored association of the annotation data.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a flowchart illustrating a method for annotating presence information, according to an exemplary embodiment;

FIG. 2 illustrates a system for annotating presence information, according to an exemplary embodiment;

FIG. 3 illustrates a system for annotating presence information, according to an exemplary embodiment;

FIG. 4 illustrates an exemplary tuple structure supporting annotation information according to an exemplary embodiment;

FIG. 5 is a flowchart illustrating a method for annotating presence information, according to an exemplary embodiment; and

FIG. 6 illustrates an exemplary graphical user interface (GUI) illustrating a display of annotated presence information, according to an exemplary embodiment.

### DETAILED DESCRIPTION

According to aspects of the invention, methods, systems, and computer program products for annotating presence information are disclosed. Well known presence protocols, such as XMPP-IM, SIP SIMPLE, and RVP, are used by presence services, and Jabber Software Foundation's pub/sub protocol as specified in Jabber Enhancement Proposal (JEP) JEP0060: Publish-Subscribe.

The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence”, each of which are published and owned by the Internet Society and incorporated here in their entirety by reference.

Generally speaking, one or more pub/sub servers are used to provide pub/sub services. The function of a pub/sub server, however, can be incorporated, either in whole or in part, into other entities. For example, according to the presence service model described in RFC 2778, two distinct agents of a presence service client are defined. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from a presence service on behalf of a presence client.

The presence model of RFC 2778 describes two types of watchers, referred to as “subscribers” and “fetchers”. A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

By way of example, aspects of an exemplary embodiment described here can employ a presence protocol as the pub/sub communication protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

According to pub/sub communication protocols, the pub/sub service stores and organizes information provided by the publisher and by the subscriber in data entities referred to as tuples. A tuple, in its broadest sense, is a data object containing one or more elements. If a tuple contains a status element it is referred to as a presence tuple (RFC 2778) and the information stored in the status element is referred to as presence information. A pub/sub service which processes presence tuples is referred to as a presence service. In addition to containing a status element, a presence tuple can include any other content.

A tuple can represent any element used to store the published information associated with a publisher or principal. The published information may include general contact information of the publisher, such as name, telephone number, email address, postal address, an IP addresses or URLs associated with the publisher, and the like, as well as other data or content. As used here, a tuple can also be a representation that maps field names to certain values to indicate that an entity or object (e.g., the principal) includes certain components, information, and/or perhaps has certain properties.

As used herein, annotation data with respect to presence information includes any data associated with the presence information that is not provided by the owner or principal of the presence information. For example, annotation data can include metadata associated with a specific principal or principal's presence information that is provided by a source other than the principal or an agent of the principal such as a presence user agent and/or presentity of the principal.

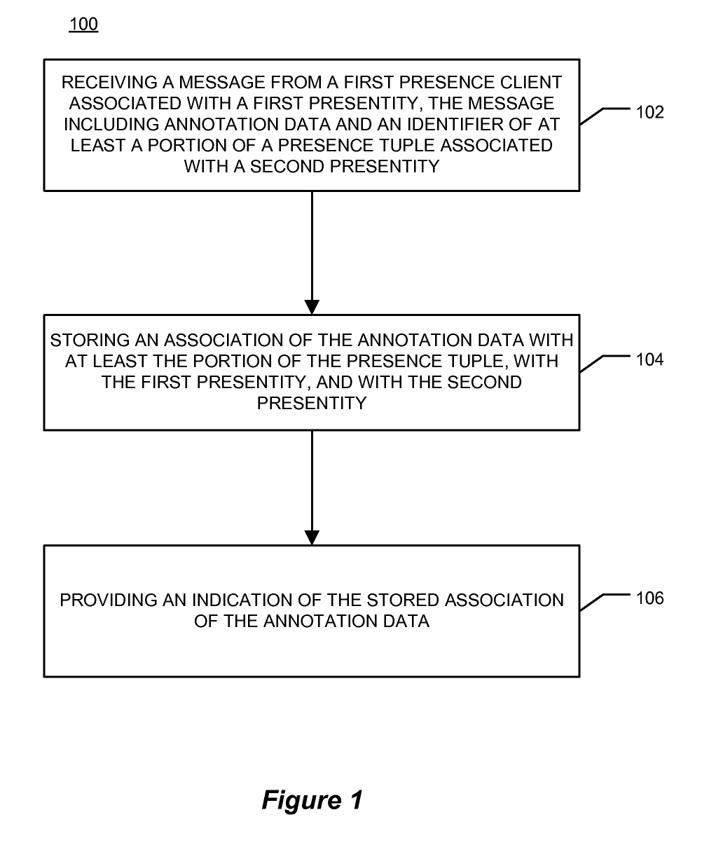

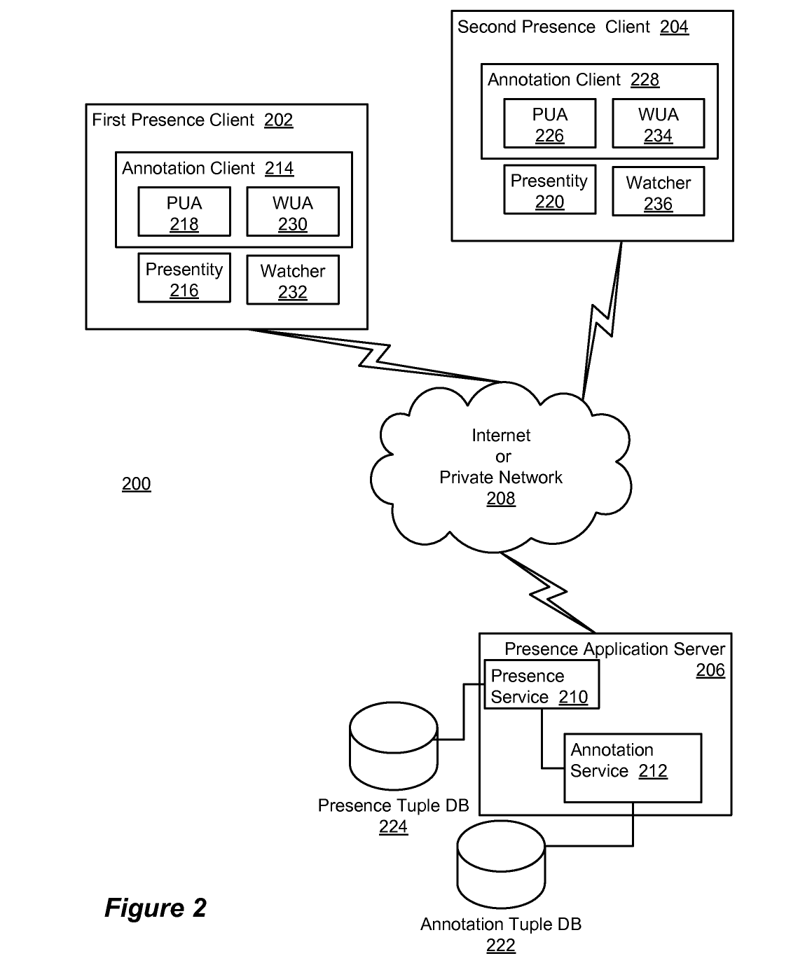

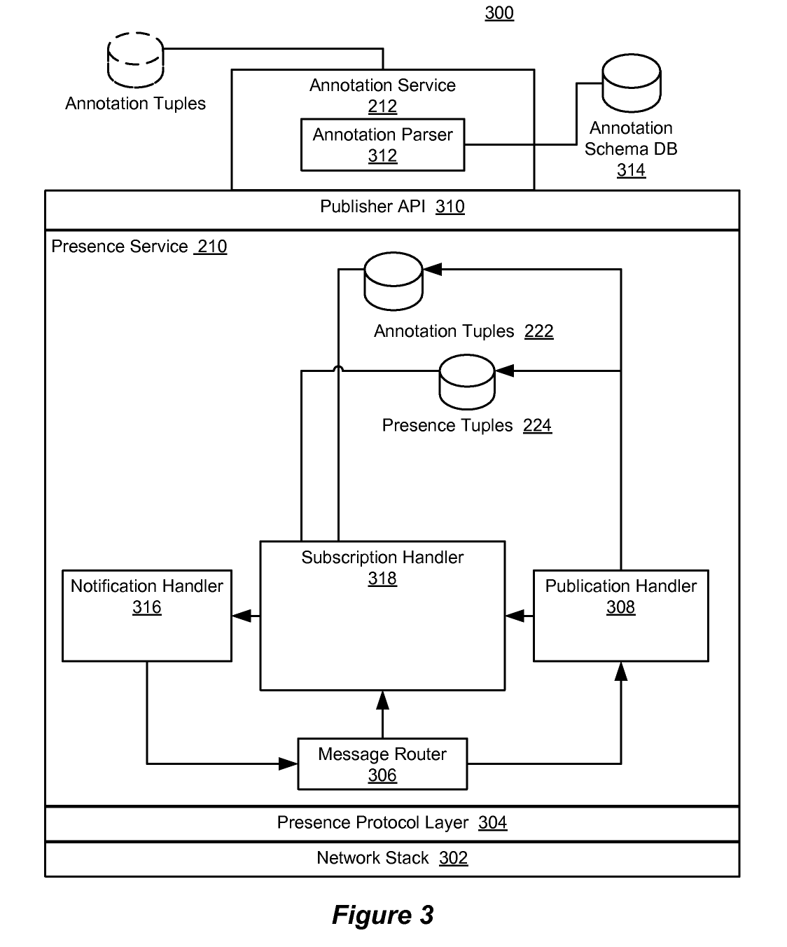

According to an aspect, a method and system for annotating presence information are described. FIG. 1 is a flowchart depicting an exemplary method 100 for annotating presence information. FIG. 2 illustrates an exemplary system 200 for annotating a presence tuple according to an exemplary embodiment. The system 200 includes a first presence client 202 and a second presence client 204 communicatively coupled to a presence application server 206 by a network 208. FIG. 3 depicts a subsystem 300 including components of the presence application server 206 including a presence service 210 and an annotation service 212. The system 200, including the subsystem 300 according to an embodiment, is described below in terms of its operation in carrying out the method 100.

In block 102 of the method 100, a message is received from a first presence client associated with a first presentity, the message including annotation data and an identifier of at least a portion of a presence tuple associated with a second presentity. The first presentity may represent a first principal, which may be, for example, a person, a device, a resource, or a service. The message includes an identifier of a presence tuple of a second presentity and annotation data. The second presentity similarly may act as an agent for a second principal.

As described above, a presentity publishes presence information on behalf of the presentity's principal to a presence tuple with an identifier allowing the presence tuple to be associated with the specific principal. In effect, a principal uses a presentity to publish information about the principal, such as the principal's current status, location, and contact information. The relationship between a principal and an associated presentity is such that the terms are often used interchangeably.

The annotation data can include at least one of a comment, a rating, a tag, a keyword-value pair, and an identifier of a third presentity. Annotation data as defined can include information, which supplements or annotates the presence information in the presence tuple of the second presentity referenced by the identifier included in the message. The identifier in the received message may identify the whole tuple or a portion of the tuple of the second presentity. The identifier allows annotation data to be associated with the presence tuple and thus the principal of the second presentity. This allows the information in a presence tuple to be supplemented with data from principals/presentities other than the owner of the presence tuple.

A system for carrying out the method 100 includes means for receiving a message from a first presence client associated with a first presentity, the message including annotation data and an identifier of at least a portion of a presence tuple associated with a second presentity. For example, in the system 200, the presence application server 206 receives a message via the network 208 from first presence client 202. The network may be a Local Area Network (LAN) and/or a Wide Area Network (WAN) including the Internet. The first presence client 202 operates as an annotation client 214 for annotating presence tuples. The first presence client, for example, provides (not shown) a processor, operating system or control program, a network subsystem, input/output subsystems, and memory subsystems in order to provide an operating environment allowing the annotation client 214 to operate. In an embodiment, the annotation client 214 is depicted as a stand alone application.

The annotation client 214 may be integrated as a service in another application such as an instant messaging application and/or voice application or may be provided via a browser as part of a network application. The annotation client 214 in an embodiment provides a user interface which receives a selected identifier of a presence tuple of a second presentity 220 and a representation of annotation data received via the user interface to be associated with at least a portion of the presence information of the second presentity 220. In the depicted embodiment, the annotation client 214 passes the annotation data and the identifier to a presence user agent (PUA) 218 which invokes the first presentity 216. The first presentity 216, in an embodiment generates a presence protocol message including the identifier and annotation data, then transmits the message using a presence protocol layer and network subsystem (not shown) over the network 208 to the presence application server 206 including the presence service 210 for processing the message and the annotation service 212 for storing the annotation data received in the message. Alternate embodiments use other protocols including proprietary protocols and messaging protocols. Alternate embodiments use various types of repositories to store including data stores without presence information. In some embodiments the annotation service and the presence service operate on separate servers. A variety of message formats supporting the publication of annotation data are described below.

Example 1 below illustrates an extended SIP SIMPLE message supporting the publication of annotation data. The <annotation> tag indicates the message includes an annotation. The <annotated> tag indicates the owner of the tuple to be annotation, thus identifying the tuple. The tag <anonymous> or an analog is supported in some embodiments to allow a user to provide an annotation for another user's tuple anonymously. The message in Example 1 provides an extended status that is to be stored permanently along with a comment concerning the principal associated with the tuple.

### EXAMPLE 1

### SIP SIMPLE Message Supporting the Publication of Annotation Data

```
<?xml version=“1.0” encoding=“UTF-8”?>
<presence xmlns=“urn:ietf:params:xml:ns:pidf”
entity=“sip:tsmothers@example.com”>
  <annotation id=“sg89ae”>
    <annotated>dsmothers@example.com</annotated>
    <anonymous>yes</anonymous>
    <alt-status>
      <extended>
        <permanent>ls dumb</permanent>
      </extended>
      <comment>Mom always liked him best.</comment>
    </alt-status>
  </annotation>
</presence>
```

Example 2 below illustrates a pub-sub message publishing annotation data with an acknowledgement from the pub-sub server. The example is an exemplary extension of the Jabber Foundation's Pub-Sub protocol specified in JEP-060. The tags used are similar to those in Example 1 and are used for similar purposes.

### EXAMPLE 2

### Pub-Sub Message (Publisher Publishes an Item with an Annotation)

```
<iq type=“set” from=”tsmothers@example.com”
to=“pubsub.jabber.org” id=“tsmothers”>
  <pubsub xmlns=“http://jabber.org/protocol/pubsub”>
    <publish node=“generic”>
      <item id=“presence/annotation”>
        <annotation id=“sg89ae”>
            <annotated>
              dsmothers@example.com
          </annotated>
            <anonymous>yes</anonymous>
            <alt-status>
                <extended>
                    <permanent>
                      ls dumb
                  </permanent>
                </extended>
                <comment>
                  Mom always liked him best.
              </comment>
            </alt-status>
        </annotation>
      </item>
    </publish>
  </pubsub>
</iq>
PubSub Server replies with success
<iq type=“result” from=“bigpublishser.com”
to=”tsmothers@example.com” id=“annotation” annotation=”41045”/>
```

Example 3 below uses an instant message (IM) protocol to publish annotation data. As above, the same XML tags are used with similar effect, but are embedded in an instant message.

### EXAMPLE 3

### IM Protocol (Subscriber Receives Event Notifications in Order)

```
<message to=“dsmothers” from=“bigpublisher.com”>
  <event xmlns=“http://jabber.org/protocol/pubsub#event”>
      <items node=“general”>
        <item id=“presence/annotation”>
          <annotation id=“sg89ae”>
              <annotated>
              dsmothers@example.com
              </annotated>
              <anonymous>yes</anonymous>
              <alt-status>
                <extended>
                  <permanent>ls dumb
                  </permanent>
                </extended>
                <comment>
                  Mom always liked him best.
                </comment>
              </alt-status>
            </annotation>
          </item>
        </items>
      </event>
    </message>
```

The message from the first presentity 216 is received by the presence application server 206 via a network stack 302 as depicted in the subsystem 300 in FIG. 3. The network stack 302 routes the message to a presence protocol layer 304. The presence protocol layer 304 then passes the message to a listening message router 306 of the presence service 210. The message router 306 is configured to receive a message from a first presence client associated with a first presentity, the message including annotation data and an identifier of at least a portion of a presence tuple associated with a second presentity;

The message router 306 determines that the message is a publish command and, as a result, passes the message content to a publication handler 308. Anonymous sending of annotation data is allowed in an embodiment as was illustrated earlier in the example message formats. In an embodiment, the received message includes identity information associated with the first presentity 216 for identifying the annotator and identity information for the second presentity 220 for identifying a tuple to be associated the annotation data received. In such an embodiment, the method can include determining whether the first presentity 216 is authorized to provide annotation data for the second presentity 220 according to the identity information. For example, the annotation service can be configured to determine whether the first presentity 216 is authorized to provide annotation data for the second presentity 220 according to the identity data.

In block 104 of method 100, the annotation data is associated with at least a portion of the presence tuple associated with the second presentity. The association typically is made using the identifier. In an embodiment, storing the association of the annotation data includes storing the annotation data and the identifier to an annotation tuple.

A system for carrying out the method 100 includes means for storing an association of the annotation data with the at least a portion of the presence tuple. For example, the annotation service 212 is configured to store an association of the annotation data with the at least a portion of the presence tuple associated with the second presentity.

Continuing the current example, the publication handler 308 passes the message content via a publisher API 310 to the annotation service 212. In an embodiment, the annotation service 212 can include an annotation parser 312 to recognize the format of the annotation data using a schema, which, for example, is stored in an annotation schema database 314. If the format of the annotation data is recognized and supported, the parsed data is converted to a format compatible for storage as an annotation tuple and stored in an annotation tuple database 222 by the annotation service 212 using the publisher API 310 to communication with the presence service 210 in order to store the annotation tuple. In an embodiment, the annotation service can be configured to store the association including the published the annotation data, the identifier of the at least a portion of the presence tuple of the second presentity 220, and an identifier of an annotation tuple to a storage location in the annotation tuple database 222.

According to an embodiment, the stored annotation tuple creates an association by storing the annotation data and the identifier of at least a portion of the presence tuple of the second presentity 220. The presence tuple associated with the second presentity 220 is stored in the presence tuple database 224 as depicted in the system 200 and the subsystem 300. The message may optionally include identity information of the first presentity 218 that in some embodiments is also stored in the annotation tuple allowing the source of the annotation to be known.

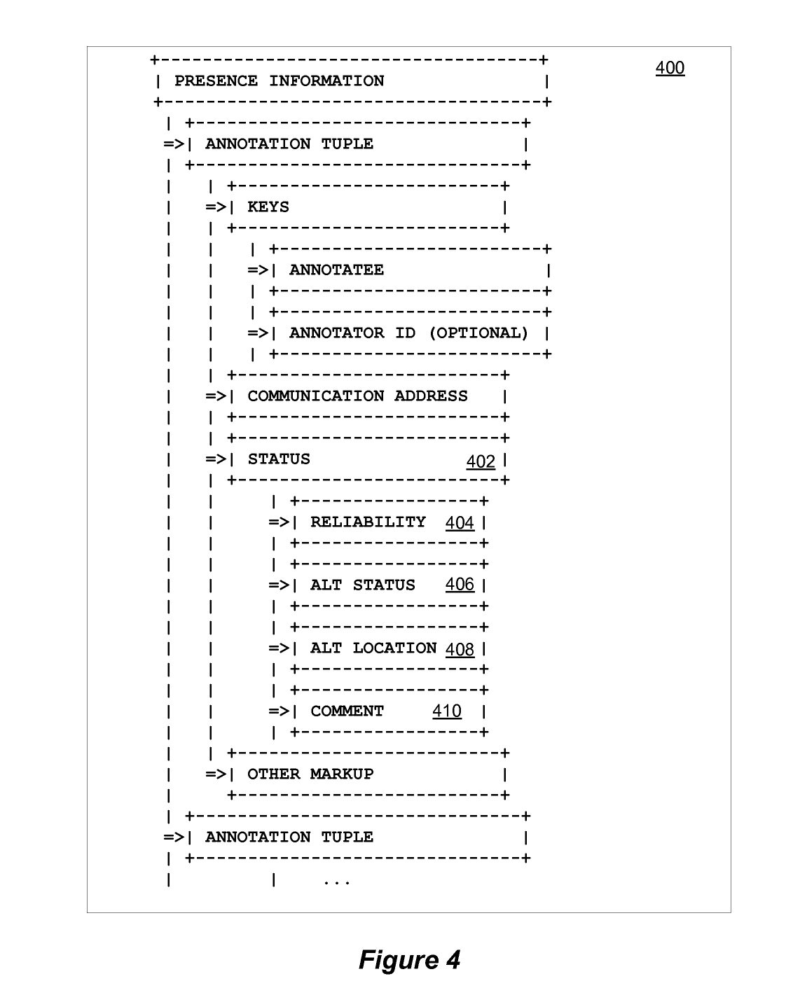

FIG. 4 illustrates an exemplary annotation tuple 400. In the annotation tuple 400, the status element 402 is associated with a variety of annotation data. For example, a reliability element 404, an alternate status element 406, an alternate location element 408, and a comment element 410 are shown associated with the status element 402.

In an alternate embodiment, the publication handler 308 includes an embodiment of an annotation service including an annotation parser and schema database. The publication handler 308, in this embodiment, detects the annotation data and the identifier of the second presentity 220. The annotation service including the annotation parser and the annotation schema database 314 creates an association by storing the annotation data and the identifier in an annotation tuple in the annotation database 222 in a manner analogous to the method just described for the previous embodiment.

While presentities that do not own a particular presence tuple are allowed to provide annotation data for the particular presence tuple, the presence information in the particular presence tuple is provided by a presentity associated with the presence tuple. In the embodiment depicted, the presence tuple of second presentity is provided by a presence user agent 226 typically operating as a component of an application of the second presence client 204. As depicted in FIG. 2, the presence user agent (PUA) 226 is a component an annotation client 228 of the second presence client 204. The second presence client 204 provides an operating environment similar to the operating environment described for the first presence client 202. Thus, a user of the second presence client 204 is allowed to provide annotation data for any number of presence tuples using the annotation client 228.

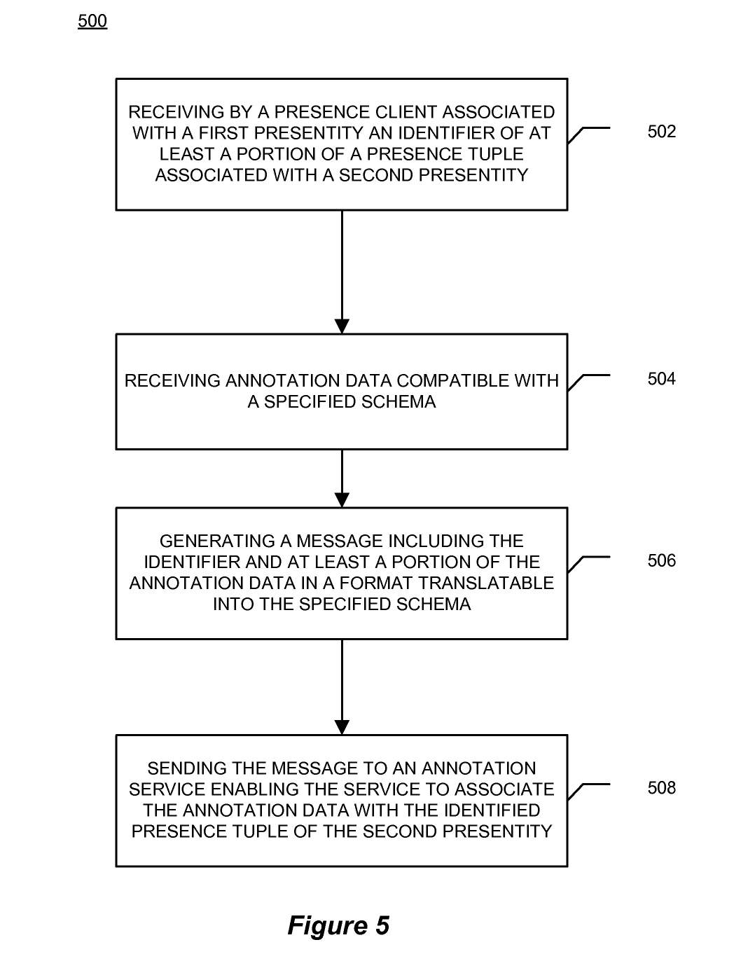

In another aspect of the subject matter disclosed herein, a method for annotating presence information is disclosed. FIG. 5 depicts an exemplary method 500 for annotating presence information from the perspective of an annotation client. At block 502, a presence client associated with a first presentity receives an identifier of at least a portion of a presence tuple associated with a second presentity. For example, the first presentity 216 receives its own presence information from the PUA 218 and receives identifiers of other presentities, such as the second presentity 220, used in publishing annotation data associated with the other presentities to the presence application server 206.

At block 504 the client receives annotation data compatible with a specified schema. For example, the PUA 218 provides a user interface of the annotation client 214 allowing the principal to provide annotation data to be associated with the second presentity 220. Annotation data for the second presentity 220 and other presentities is provided in the same manner that presence information for the first presentity 216 is provided, by using the PUA 218, the first presentity 216, and an annotation user interface. The principal provides annotation data for the second presentity 220 using the annotation interface that is compatible with a schema for the annotation data. The annotation interface in the described example is provided by the PUA 218, which ensures the interface is compatible with a specified schema for annotation data. The annotation data and the identifier of the second presentity are received by the PUA 218 for sending to the presence application server 206. The PUA 218, upon validating the received annotation data, invokes the first presentity 216 providing the annotation data and the identifier associated with the presence tuple of the second presentity 220. Alternatively, presence information for the first presentity 216 and/or annotation data for the second presentity 220 and other presentities may be provided by an agent of the second presentity 216 and the associated principal.

At block 506, the client generates a message including the identifier and at least a portion of the annotation data in a format translatable into the specified schema. For example, the first presentity 216 generates a message including a publish command containing at least a portion of the annotation data associated with second presentity's 220 presence information and an identifier for identifying the second presentity 220.

At block 508 the client sends the message to an annotation service enabling the service to associate the annotation data with the presence tuple associated with a second presentity. For example, the first presentity 216 sends the message to the annotation service 212 via the presence service 210 using, for example, a presence protocol layer and a network subsystem of the presence client 202 running under control of an operating system or control program as executed by a processor. The annotation service 212 stores at least a portion of the annotation data in an annotation tuple in the annotation tuple database 222 where the annotation tuple is associated with presence tuple of the second presentity 220 using the identifier of the second presentity 220.

The presence tuple identifier of the second presentity 220 is used by a presence client, such as the annotation client 214 to initiate a subscription issued using via the WUA 230 for receiving notifications of changes to annotation data and/or presence information associated with the second presentity's 220. The WUA 230 makes use of the watcher 232 to send a subscription command to the presence service 210 enabling the watcher 232 to receive notifications associated with changes to the annotation data and or presence information associated with the presence tuple of the second presentity 220. The notification information is passed to the WUA 230 which typically transforms the data into a format compatible with the annotation client 214 for processing including presenting a representation of the presence information or a portion of the presence information of the second presentity 220 or other watched presentity via a user interface for displaying and receiving annotation data. Other presence clients can receive notifications of changes to annotation data associated with the second presentity 220 in the same manner including the second presence client 204. In an embodiment, the second presence client 204 may watch for updates to annotation data associated with its own presence information using the WUA 234 and the watcher 236 receiving notifications related to changes in associated annotation data.

The second presence client 204 can receive notifications of new, updated, and deleted annotations associated with its own presence information via a watcher user agent (WUA) 230. The presence tuple identifier of the second presentity 220 is used by the annotation client 228 to initiate a subscription issued using via the WUA 230 for receiving notifications of changes to annotation information associated with the second presentity's 220 annotation data. The WUA 230 makes use of the watcher 232 to send a subscription command to the presence service 210 enabling the watcher 232 to receive notifications associated with changes to the annotation information associated with the presence tuple of the second presentity 220. The notification information is passed to the WUA 230 which typically transforms the data into a format compatible with the annotation client 228 for processing including presenting a representation of the annotation data and the associated presence tuple or portion thereof. Other presence clients can receive notifications of changes to annotation data associated with the second presentity 220 in the same manner. In an embodiment, the second presence client may watch tuples belonging to other presentities using the WUA 234 and the watcher 236 receiving notifications related to changes in associated presence information and/or annotation data.

In block 106 of method 100, an indication of the stored association between the annotation data and the presence tuple is provided. The indication can be provided in a number of formats using a variety of communications means. For example, providing an indication of the stored association of the annotation data can include sending a message to a client including the second presentity 220. Sending a message to a client including the second presentity 220 can include sending a notification including at least a portion of the annotation data to a watcher 236 of the second presentity 220. In another example, providing an indication of the stored association of the annotation data includes generating a notification including at least a portion of the annotation data and transmitting the notification to a recipient.

A system for carrying out the method 100 includes means for providing an indication of the stored association of the annotation data. For example, a notification handler 316 is configured to provide an indication of the stored association of the annotation data. The subscription handler 316 can provide the indication in response to a directed publish message including the identifier of the client to be notified, such as the second presence client 204. Directed publish command received by the publication hander 308, in one embodiment, cause the publication handler to invoke the notification handler 316 to generate and send a directed notify message to the identified recipient(s). In another embodiment, the notification handler 316 is invoked by a subscription handler 318 when invoked by the publication handler 308. If a subscription list is associated with at least one of a presence tuple and its associated annotation tuple(s), the subscription handler is invoked after a tuple update to process any subscribers on the subscription list. Processing a subscriber by the subscription handler 318 includes invoking the notification hander to generate and send a notification message including information associated with an updated tuple to the subscriber. In an embodiment, the subscription handler 318 is configured to invoke the notification handler 316 to send a message based on the stored annotation data to a watcher of the second presentity. In another embodiment, the subscription hander 318 using the notification handler 316 is configured to generate a notification including at least a portion of the annotation data and transmitting the notification to a recipient.

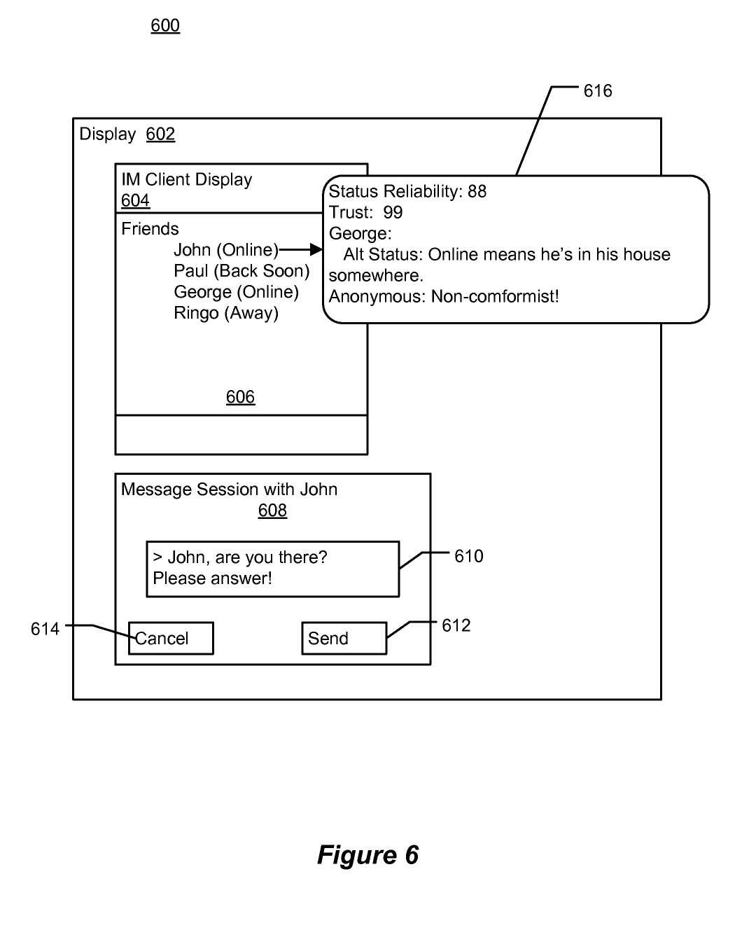

The indication can be sent to a recipient device for presentation to a user. In the exemplary embodiment illustrated in FIG. 6, one form an indication takes is depicted in the Graphical User Interface (GUI) display 600. The GUI display 600 illustrates a display area 602 including an instant messenger (IM) client display 604. The IM client display 604 includes a friend's list pane 606 showing a list of friends and their current status. As is typical of IM clients a user may select a friend to start an instant messaging session. Starting a session causes the instant messenger software to display a message session window 608 allowing a user to enter and send messages to one or more friends, and to see messages received from the friends participating in the session. In the embodiment shown, the messages are displayed in a message pane 610 where the user enters new messages as well. After entering a new message, the instant messenger sends the new message when it detects a selection of the “Send” button 612. A session is ended when a selection of the “Cancel” button 614 is detected.

The flyover box 616 provides annotation data associated with the principal John and his presentity. Individual annotations, such as a comment from George, are shown. Anonymous data may be provided as well. Aggregated annotation data such as “Status Reliability” is shown too. Status Reliability is a measure of how accurate annotators believe John's presence status is. Aggregate annotation data providing a measure of how trustworthy others perceive John to be is also shown as another piece of exemplary annotation data. The annotation data can be retrieved as needed from a storage repository such as an SQL database or it may be subscribed to via a presence or real-time pub-sub service as depicted in system 200 including subsystem 300 in FIGS. 2 and 3.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11 (a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for annotating presence information, the method comprising:
receiving a message from a first presence client associated with a first presentity, the message including annotation data and an identifier of at least a portion of a presence tuple associated with a second presentity;
storing an association of the annotation data with the at least a portion of the presence tuple associated with the second presentity; and
providing an indication of the stored association of the annotation data.

2. The method of claim 1 wherein storing the association of the annotation data includes parsing the annotation data and determining whether the annotation data is formatted according to a predefined annotation schema.

3. The method of claim 2 wherein storing the association of the annotation data includes storing the annotation data in an element of the presence tuple associated with the second presentity based on the predefined annotation schema.

4. The method of claim 1 wherein the received message includes identity information associated with the first presentity.

5. The method of claim 4 comprising determining whether the first presentity is authorized to provide annotation data for the second presentity according to the identity information.

6. The method of claim 1 wherein providing an indication of the stored association of the annotation data includes sending a message to a client.

7. The method of claim 6 wherein sending a message to a client including the second presentity includes sending a notification including at least a portion of the annotation data to a watcher of the second presentity.

8. The method of claim 1 wherein providing an indication of the stored association of the annotation data includes generating a notification including at least a portion of the annotation data and transmitting the notification to a recipient.

9. The method of claim 1 wherein the annotation data includes at least one of a comment, a rating, a tag, a keyword-value pair, and an identifier of a third presentity.

10. A system for annotating presence information, the system comprising:
a message router configured to receive a message from a first presence client associated with a first presentity, the message including annotation data and an identifier of at least a portion of a presence tuple associated with a second presentity;
an annotation service configured to store an association of the annotation data with the at least a portion of the presence tuple associated with the second presentity; and
a notification handler configured to provide an indication of the stored association of the annotation data.

11. The system of claim 10 wherein the annotation service includes an annotation parser configured to parse the annotation data and determine whether the annotation data is formatted according to a predefined annotation schema.

12. The system of claim 11 wherein the annotation service is configured to store the annotation data in an element of the presence tuple associated with the second presentity based on the predefined annotation schema.

13. The system of claim 10 wherein the annotation service is configured to publish the annotation data and the identifier to an annotation tuple.

14. The system of claim 10 wherein the received message includes identity information associated with the first presentity.

15. The system of claim 10 wherein the annotation service is configured to determine whether the first presentity is authorized to provide annotation data for the second presentity according to the identity data.

16. The system of claim 10 wherein the notification handler is configured to send a message based on the annotation data to a watcher of the second presentity.

17. The system of claim 16 wherein the notification handler is configured to generate a notification including at least a portion of the annotation data and transmitting the notification to a recipient.

18. The system of claim 10 wherein the annotation data includes at least one of a comment, a rating, a tag, a keyword-value pair, and an identifier of a third presentity.

19. A method for annotating presence information, the method comprising:
receiving by a presence client associated with a first presentity an identifier of at least a portion of a presence tuple associated with a second presentity;
receiving annotation data compatible with a specified schema;
generating a message including the identifier and at least a portion of the annotation data in a format translatable into the specified schema; and
sending the message to an annotation service enabling the service to associate the annotation data with the presence tuple associated with a second presentity.

20. The method of claim 19 wherein sending the message to an annotation service includes publishing the annotation data and the identifier to an annotation tuple.

21. A computer readable medium containing a computer program, executable by a machine, for annotating presence information, the computer program comprising executable instructions for:
receiving a message from a first presence client associated with a first presentity, the message including annotation data and an identifier of at least a portion of a presence tuple associated with a second presentity;
storing an association of the annotation data with the at least a portion of the presence tuple associated with the second presentity; and
providing an indication of the stored association of the annotation data.

22. A system for annotating presence information, the system comprising:
means for receiving a message from a first presence client associated with a first presentity, the message including annotation data and an identifier of at least a portion of a presence tuple associated with a second presentity;
means for storing an association of the annotation data with the at least a portion of the presence tuple associated with the second presentity; and
means for providing an indication of the stored association of the annotation data.
